(19) United States
(12) Patent Application Publication
(10) Pub. No.: US 2025/0309330 A1
(43) Pub. Date: Oct. 2, 2025

(54) BATTERY SYSTEM

(71) Applicant: HONDA MOTOR CO., LTD., Tokyo (JP)

(72) Inventor: Hidemasa USUI, Saitama (JP)

(21) Appl. No.: 19/075,797

(22) Filed: Mar. 11, 2025

(30) Foreign Application Priority Data
Mar. 30, 2024 (JP) 2024-058339

(51) Int. Cl. H01M 10/04; H01M 10/42; H01M 10/613; H01M 10/647; H01M 10/6567; H01M 50/211; H01M 50/242

(52) U.S. Cl. CPC H01M 10/0481; H01M 10/425; H01M 10/613; H01M 10/647; H01M 10/6567; H01M 50/211; H01M 50/242

(57) ABSTRACT

A battery system according to an aspect of the present invention includes: a cell stack in which a plurality of battery cells are stacked; a pair of end plates disposed at opposite ends of the cell stack in a stacking direction, respectively; at least one elastic container having an interior filled with a gas, the at least one elastic container being disposed between the battery cells and/or between the set of the plurality of battery cell and each of the end plates; a pipe having a compressor and a relief valve; a sub-pipe connecting the pipe to the at least one elastic container; and a controller.

This application is based on and claims the benefit of priority from Japanese Patent Application No. 2024-058339, filed on 30 Mar. 2024, the content of which is incorporated herein by reference.

### BACKGROUND OF THE INVENTION

### Field of the Invention

The present invention relates to a battery system.

### Related Art

In recent years, research and development of battery systems that contribute to energy efficiency has been carried out in order to ensure many people have access to affordable, reliable, sustainable, and advanced energy. The battery system is formed by combining and modularizing a plurality of battery cells, and generally includes a cell stack in which the plurality of battery cells are stacked, and a pair of end plates disposed at opposite ends of the cell stack in the stacking direction. The battery system is used in applications requiring a large current and a high voltage, such as driving a motor of an electric vehicle or a hybrid electric vehicle.

Regarding the battery systems, studies are conducted on application of pressure in the stacking direction of battery cells by interposing a cushioning member between the battery cells or between the cell stack and the end plate. Known cushioning members include a cushioning member having a deformable chamber and a system for supplying a fluid for deforming the chamber (see Patent Document 1) and elastic spring bodies such as a leaf spring and a liquid spring (see Patent Document 2 and Patent Document 3).

Patent Document 1: Japanese Unexamined Patent Application, Publication No. 2020-64848

Patent Document 2: Japanese Unexamined Patent Application, Publication No. 2021-96974

Patent Document 3: European Patent Application, Publication No. 3886202

### SUMMARY OF THE INVENTION

A challenge for the techniques relating to battery systems is to increase the electrical capacity and reduce the size of the battery module. In order to increase the electrical capacity of a battery system, it is effective to apply a uniform pressure to the entirety of each of the battery cells incorporated in the battery system through a cushioning members. A fluid cushion filled with a fluid has a highly uniform internal pressure, and therefore, can apply a highly uniform pressure to the entirety of each of the battery cells. On the other hand, a lithium metal battery as a battery cell is under study. In the lithium metal battery, lithium ions function as a charge transfer medium, lithium metal is precipitated on a negative electrode layer at the time of charge, and lithium ions deriving from the lithium metal are transferred to a positive electrode layer at the time of discharge. The lithium metal battery greatly changes in thickness due to charge and discharge. For this reason, in order to apply a uniform pressure to the lithium metal battery by means of a fluid cushion, it is necessary to reduce the amount of the internal fluid at the time of charge and to increase the amount of the internal fluid at the time of discharge. However, when a fluid tank is employed to adjust the amount of the internal fluid in the fluid cushion, it is difficult to reduce the size of the battery system.

The present invention has been made in view of the above circumstances, and an object of the present invention is to provide a battery system that can apply a uniform pressure to battery cells even in a case where the battery cells change greatly in thickness due to charge and discharge of the battery cells, and can be reduced in size. The present invention contributes to energy efficiency by extension.

The present inventors have made the present invention based on the findings that the above objects can be achieved by a configuration in which a gas cushion, which is an elastic container having an interior filled with a gas, is disposed between battery cells or between the battery cell and the end plate, the gas cushion is connected to a pipe having a compressor and a relief valve via a sub-pipe, and the compressor and the relief valve are controlled based on a pressure of the gas cushion. Thus, the present invention provides the following.

A first aspect of the present invention is directed to a battery system including: a cell stack in which a set of a plurality of battery cells are stacked; a pair of end plates disposed at opposite ends of the cell stack in a stacking direction, respectively; at least one elastic container having an interior filled with a gas, the at least one elastic container being disposed between the battery cells and/or between the set of the plurality of battery cell and each of the end plates; a pipe having a compressor and a relief valve; a sub-pipe connecting the pipe to the at least one elastic container; and a controller. The controller actuates the compressor to introduce the gas into the pipe in a case where a pressure of the at least one elastic container is less than a preset value, and actuates the relief valve to release the gas from the pipe in a case where the pressure of the at least one elastic container exceeds the preset value.

According to the battery system of the first aspect, a decrease in the pressure of the at least one elastic container, which is caused when the thicknesses of the battery cells decrease due to discharge or the like, can be canceled by introducing the gas by the compressor disposed on the pipe. Furthermore, an increase in the pressure of the at least one elastic container, which is caused when the thicknesses of the battery cells increase due to charge or the like and the at least one elastic container is pressurized, can be suppressed by releasing the gas through the relief valve disposed on the pipe. Therefore, even in the case where the thicknesses of the battery cells change greatly due to charge and discharge, a uniform pressure can be applied to the battery cells. In addition, a tank for storing the gas is not necessary, size reduction is facilitated.

According to a second aspect of the present invention, in the battery system of the first aspect, the elastic container is housed in an outer elastic container, and a space between the elastic container and the outer elastic container is filled with a liquid.

According to the battery system of the second aspect, heat generated by the battery cells can be absorbed by the liquid filling the space between the elastic container and the outer elastic container, thereby making it possible to suppress an increase in the temperature of the battery cells that can be caused by charge and discharge.

The present invention provides a battery system that can apply a uniform pressure to battery cells even in a case where the battery cells change greatly in thickness due to charge and discharge of the battery cells, and can be reduced in size.

### BRIEF DESCRIPTION OF THE DRAWINGS

FIG. 1 is a schematic diagram illustrating a battery system according to a first embodiment of the present invention;

FIG. 2 is a cross-sectional view of a battery cell that can be used in the battery system according to the first embodiment of the present invention;

FIG. 3 is a schematic diagram illustrating a charged state of the battery system in FIG. 1;

FIG. 4 is a schematic diagram illustrating a battery system according to a second embodiment of the present invention; and

FIG. 5 is a schematic diagram illustrating a charged state of the battery system in FIG. 4.

### DETAILED DESCRIPTION OF THE INVENTION

Embodiments of the present invention will be described below with reference to the drawings. It should be noted the following embodiments illustrate the present invention by way of example, and the present invention is not limited to the following embodiments.

### First Embodiment

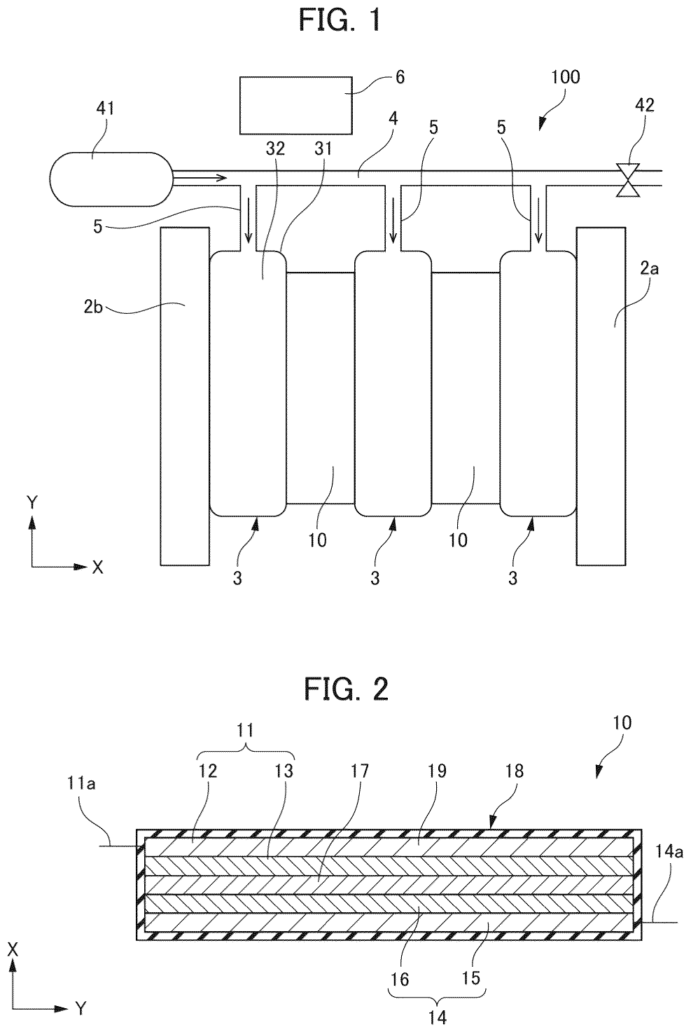

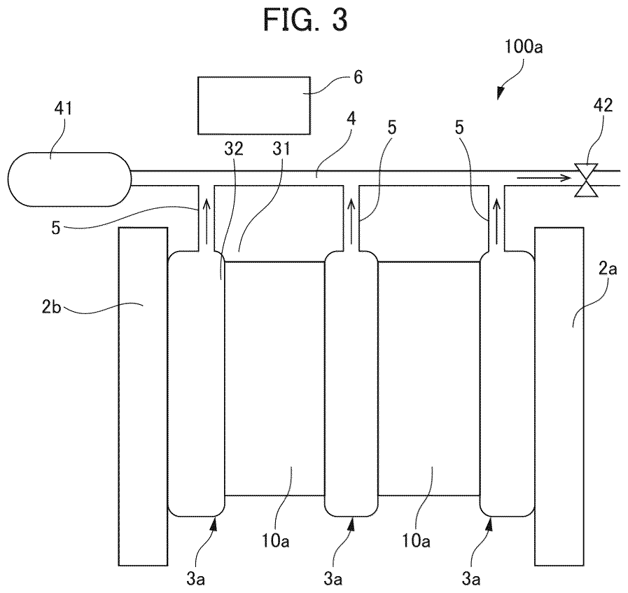

FIG. 1 is a schematic diagram illustrating a battery system according to a first embodiment of the present invention. FIG. 2 is a cross-sectional view of a battery cell that can be used in the battery system according to the first embodiment of the present invention. FIG. 3 is a schematic diagram illustrating a charged state of the battery system in FIG. 1.

As illustrated in FIG. 1, the battery system 100 of the present embodiment includes a cell stack 1, a pair of end plates 2a and 2b, elastic container 3 each having an interior filled with a gas (hereinafter also referred to as gas cushions 3), a pipe 4, sub-pipes 5 connecting the gas cushions 3 and the pipe 4, and a controller (hereinafter also referred to as a cushion controller 6).

The cell stack 1 is a stack of a set of a plurality of (two in FIG. 1) battery cells 10 that are stacked. The end plates 2a and 2b are disposed at opposite ends of the cell stack 1 in the stacking direction (X direction in FIG. 1), respectively. The gas cushions 3 are each disposed between the battery cells 10 and between the set of the plurality of battery cells 10 and each of the end plates 2a and 2b.

Each battery cell 10 is a lithium metal battery in which lithium ions serve as a charge transfer medium. As illustrated in FIG. 2, each battery cell 10 includes an electrode laminate 18 in which a positive electrode layer 11 and a negative electrode layer 14 are laminated with a solid electrolyte layer 17 interposed therebetween, and an exterior body 19 that houses the electrode laminate 18. The positive electrode layer 11 includes a positive electrode current collector 12 and a positive electrode active material layer 13. The negative electrode layer 14 includes a negative electrode current collector 15 and a metal layer 16. When the battery cell 10 is charged, lithium ions are released from the positive electrode active material layer 13, pass through the solid electrolyte layer 17, precipitate on a surface of the metal layer 16 of the negative electrode layer 14, and form a lithium precipitation layer, whereby the thickness of the negative electrode layer 14 increases. The lithium precipitation layer functions as a negative electrode active material layer, and is lost by releasing lithium ions during discharge. For this reason, the volume of each battery cell 10 changes due to charge and discharge. Therefore, the pressure that the battery cells 10 apply to the gas cushions 3 changes due to charge and discharge. The stacking direction (X direction in FIG. 2) of the electrode laminate 18 is the same as the stacking direction of the cell stack 1. That is, the set of the plurality of battery cells 10 forming the cell stack 1 are stacked along the stacking direction of the electrode laminate 18. Although the battery cell 10 illustrated in FIG. 2 includes one electrode laminate 18 housed in the exterior body 19, a plurality of electrode laminates 18 may be housed in the exterior body 19.

The positive electrode current collector 12 may include any material and have any shape as long as the material and shape allow the positive electrode current collector 12 to have a function of collecting a current from the positive electrode layer 11. Examples of the material for the positive electrode current collector 12 include aluminum, an aluminum alloy, stainless steel, nickel, iron, titanium, etc., and among them, aluminum, an aluminum alloy, and stainless steel are preferred. Examples of the shape of the positive electrode current collector 12 include a foil shape, a plate shape, etc.

The positive electrode active material layer 13 contains at least one positive electrode active material. As the positive electrode active material, any of positive electrode active materials used in a positive electrode layer of a general solid secondary battery can be used, without any particular limitation. Examples of the positive electrode active material include a layered active material containing lithium, a spinel active material, an olivine active material, etc. Specific examples of the positive electrode active material include lithium cobalt oxide (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), hetero-element-substituted Li—Mn spinel represented by Li₁₊ₓMn_{2-x-y}MO₄ (x+y=2, and M is at least one selected from Al, Mg, Co, Fe, Ni, and Zn), lithium titanate (an oxide containing Li and Ti), and lithium metal phosphate (LiMPO₄, where M is at least one selected from Fe, Mn, Co, and Ni).

The positive electrode active material layer 13 may optionally contain a solid electrolyte from the viewpoint of improving lithium ion conductivity. Furthermore, the positive electrode active material layer 13 may optionally contain a conductive additive in order to improve electrical conductivity. Furthermore, the positive electrode active material layer 13 may optionally contain a binder from the viewpoint of imparting flexibility. The solid electrolyte, the conductive additive, and the binder are not particularly limited, and those used in a positive electrode layer of a general solid secondary battery can be used, without any particular limitation.

A positive electrode lead 11a is provided, and the material constituting the positive electrode lead 11a may be the same as or different from the material constituting the positive electrode current collector 12. The positive electrode lead 11a may be integrally connected to the positive electrode current collector 12.

The negative electrode current collector 15 may include any material and have any shape as long as the material and shape allow the negative electrode layer 14 to have a function of collecting a current. Examples of the material for the negative electrode current collector 15 include nickel, copper, stainless steel, etc. Examples of the shape of the negative electrode current collector 15 include a foil shape, a plate shape, etc.

The metal layer 16 may include any material and have any shape as long as the material and shape allows the metal layer 16 to have a function of making lithium ions densely precipitate. As the metal layer 16, a metal lithium layer or a layer of a metal that is alloyed with lithium can be used. Examples of the metal that is alloyed with lithium include Mg, Si, Au, Ag, In, Ge, Sn, Pb, Al, Zn, etc. The metal forming the metal layer 16 may be in the form of powder or a thin film. Using the negative electrode layer 14 including the metal layer 16 makes it possible to form a uniform lithium precipitation layer on a surface of the metal layer 16.

A negative electrode lead 14a is provided, and the material constituting the negative electrode lead 14a may be the same as or different from the material constituting the negative electrode current collector 15. The negative electrode lead 14a may be integrally connected to the negative electrode current collector 15.

The solid electrolyte layer 17 contains at least one solid electrolyte. The solid electrolyte is not particularly limited as long as it has lithium ion conductivity, and examples of the solid electrolyte include a sulfide solid electrolyte, an oxide solid electrolyte, a nitride solid electrolyte, a halide solid electrolyte, etc. Examples of the sulfide solid electrolyte include Li₂S-P₂S₅, Li₂S-P₂S₅-LiI, etc. The sulfide solid electrolyte may have an argyrodite type crystal structure. Examples of the oxide solid electrolyte include a NASICON type oxide, a garnet type oxide, and a perovskite type oxide. An example of the NASICON type oxide is an oxide containing Li, Al, Ti, P, and O (e.g., Li_{1.5}Al_{0.5}Ti_{1.5} (PO₄) ₃). An example of the garnet type oxide is an oxide containing Li, La, Zr, and O (e.g., Li₇La₃Zr₂O₁₂). An example of the perovskite type oxide is an oxide containing Li, La, Ti, and O (e.g., LiLaTiO₃).

The exterior body 19 is capable of expanding and contracting in accordance with a change in the volumes of the battery cells 10 caused by charge and discharge. The exterior body 19 may be constituted by a material such as a laminate film. The laminate film may have a three-layer structure in which an inner resin layer, a metal layer, and an outer resin layer are laminated in this order from the inner side. The outer resin layer may be, for example, a polyamide (nylon) layer or a polyethylene terephthalate (PET) layer, the metal layer may be, for example, an aluminum layer, and the inner resin layer may be, for example, a polyethylene layer or a polypropylene layer.

The end plates 2a and 2b have a function of restraining the cell stack 1 in the stacking direction. The end plates 2a and 2b exert a restraining force by way of which a surface pressure applied to the cell stack 1 through the gas cushions 3 can be adjusted. The end plates 2a and 2b may be constituted by any of various materials used for end plates for battery systems, without any particular limitation. The end plates 2a and 2b may be fastened with a restraining tool such as a binding bar.

Each gas cushion 3 is constituted by an elastic container 31 having an interior filled with a gas 32. The elastic container 31 is made of a contractible elastic body. Examples of the material for the elastic container 31 include a rubber, an elastomer, a laminate film, etc. Examples of the gas 32 include air, a non-combustible gas (e.g., nitrogen, carbon dioxide, or the like), etc.

The pipe 4 has a compressor 41 and a relief valve 42. In the present embodiment, the compressor 41 is disposed at one end of the pipe 4, and the relief valve 42 is disposed at the other end. The pipe 4 is connected to the gas cushions 3 via the sub-pipes 5. The pressure of the gas cushions 3 (the pressure applied to the battery cells 10 by the gas cushions 3) can be adjusted by adjusting the pressure in the pipe 4 by means of the compressor 41 and the relief valve 42. The pressure in the pipe 4 is adjusted to fall within a range of, for example, 0.90 MPa or more and less than 1.0 MPa, although the pressure depends on conditions such as a use state (during charge or discharge), an outside air temperature and the like.

The cushion controller 6 controls the compressor 41 and the relief valve 42 based on the pressure of the gas cushions 3. When the pressure of the gas cushions 3 is less than a preset value, the cushion controller 6 actuates the compressor 41 to introduce the gas 32 into the pipe 4. On the other hand, when the pressure of the gas cushions 3 exceeds the preset value, the cushion controller 6 actuates the relief valve 42 to release the gas 32 from the pipe 4. The preset value for the pressure of the gas cushions 3 may be determined in consideration of the state (a charged state or a discharged state) of the battery cells 10 and an outside air temperature.

A control process in a case where the pressure of the gas cushions 3 becomes less than the preset value will be described with reference to FIG. 1. The arrows in FIG. 1 indicate flow of the gas 32 that takes place when the pressure of the gas cushions 3 becomes less than the preset value. When the thicknesses of the battery cells 10 decrease due to discharge or the like and the thicknesses of the gas cushions 3 increase, the pressure of the gas cushions 3 decreases. In response to the pressure of the gas cushions 3 becoming less than the preset value, the cushion controller 6 actuates the compressor 41. The compressor 41 introduces the gas 32 into the pipe 4, which increases the pressure in the pipe 4. The increase in the pressure in the pipe 4 causes the gas 32 to flow into the gas cushions 3 through the sub-pipes 5. As a result, the pressure of the gas cushions 3 increases. In response to the pressure of the gas cushions 3 increasing to reach the preset value, the cushion controller 6 stops the compressor 41.

A control process in a case where the pressure of the gas cushions 3 exceeds the preset value will be described with reference to FIG. 3. The arrows in FIG. 3 indicate flow of the gas 32 that takes place when the pressure of the gas cushions 3 exceeds the preset value. The battery system 100a is in a charged state, and the thicknesses of the battery cells 10a increase due to charge. Due to the increased thicknesses of the battery cells 10a, the gas cushions 3a are pressurized to decrease in thickness. Due to the decrease in the thicknesses of the gas cushions 3a, the pressure of the gas cushions 3a increases. In response to the pressure of the gas cushions 3a increasing to exceed the preset value, the cushion controller 6 actuates the relief valve 42. The gas 32 in the gas cushions 3a passes through the sub-pipes 5 and the pipe 4, and then, is released to the outside via the relief valve 42, whereby the pressure of the gas cushions 3 decreases. Therefore, even if the thicknesses of the battery cells 10a increase, the pressure of the gas cushions 3a is kept from increasing excessively, and a uniform pressure can be applied to the battery cells 10a. In response to the pressure of the gas cushions 3 decreasing to reach the preset value, the cushion controller 6 stops the relief valve 42.

The pressure of the gas cushions 3 can be measured using, for example, a pressure sensor. The pressure in the pipe 4 may be measured as the pressure of the gas cushions 3. For example, the pressure of the gas cushions 3 may be calculated by the following equation (1), which is based on Boyle-Charl's law. P×V/T=constant (1) In the equation (1), P represents the pressure of the gas cushions, V represents the volume of the gas cushions, and T represents the temperature of the gas cushions.

According to the battery system 100 of the present embodiment having the above-described configuration, a decrease in the pressure of the gas cushions 3, which is caused when the thicknesses of the battery cells 10 decreases due to discharge or the like, can be canceled by introducing the gas 32 by the compressor 41 disposed on the pipe 4. Furthermore, an increase in the pressure of the gas cushions 3, which is caused when the thicknesses of the battery cells 10 increase due to charge or the like and the gas cushions 3 are pressurized, can be suppressed by releasing the gas 32 through the relief valve 42 disposed on the pipe 4. Therefore, even in the case where the thicknesses of the battery cells 10 change greatly due to charge and discharge, a uniform pressure can be applied to the battery cells 10. In addition, a tank for storing the gas 32 is not necessary, size reduction is facilitated.

### Second Embodiment

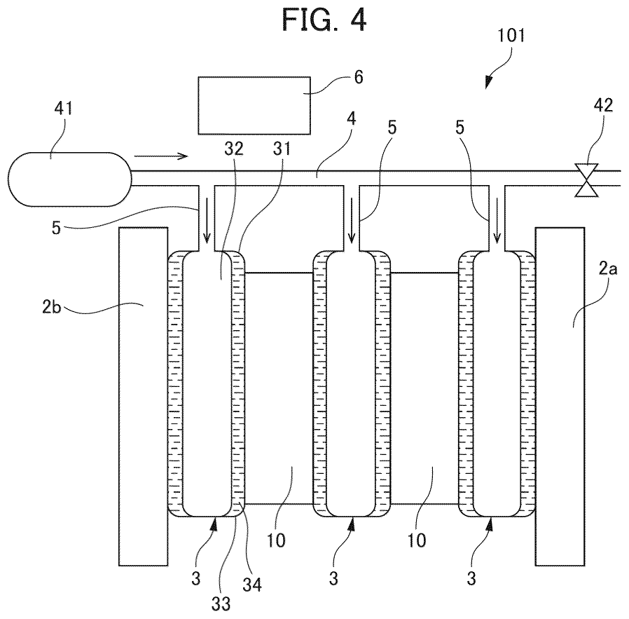

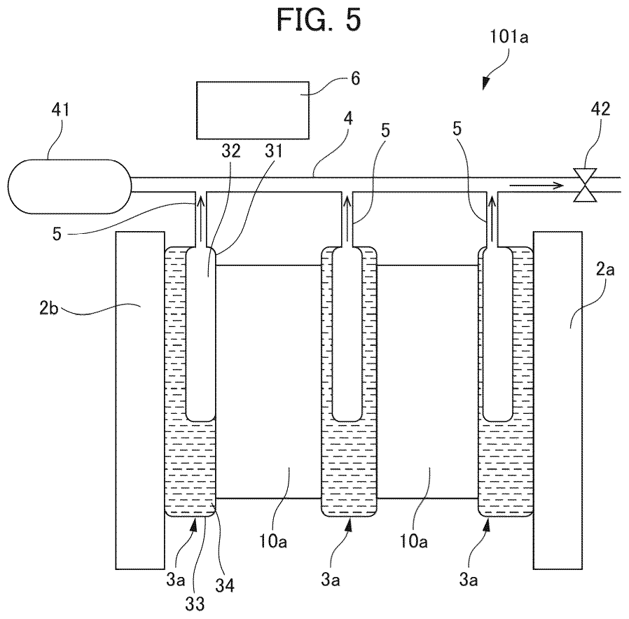

FIG. 4 is a schematic diagram illustrating a battery system according to a second embodiment of the present invention. FIG. 5 is a schematic diagram illustrating a charged state of the battery system in FIG. 4. The arrows in FIG. 4 indicate flow of a gas 32 that takes place when the thicknesses of battery cells 10a decrease. The arrows in FIG. 5 indicate flow of the gas 32 that takes place when the thicknesses of the battery cells 10a increase.

As illustrated in FIG. 4, the battery system 101 of the present embodiment is the same as the battery system 100 of the first embodiment except that an elastic container 31 of each gas cushion 3 is housed in an outer elastic container 33 and a space between the elastic container 31 and the outer elastic container 33 is filled with a liquid 34. Therefore, components common to the battery system 100 of the first embodiment are denoted by the same reference signs, and description thereof is omitted.

The outer elastic container 33 is made of a contractible elastic body. Examples of the material for the outer elastic container 33 include a rubber, an elastomer, a laminate film, etc. Examples of the liquid 34 include a mineral-based hydraulic fluid, a phosphoric ester-based hydraulic fluid, water, a glycol-based solvent, etc. Each outer elastic container 33 is in contact with the battery cell 10, whereby heat generated by the battery cell 10 can be absorbed by the liquid 34.

In the battery system 101 of the present embodiment, when the thicknesses of the battery cells 10 decrease due to discharge or the like and the pressure of the gas cushions 3 becomes less than a preset value, a cushion controller 6 actuates a compressor 41. As illustrated in FIG. 4, the compressor 41 introduces a gas 32 into a pipe 4, and the gas 32 flows into the gas cushions 3 through sub-pipes 5, whereby the pressure of the gas cushions 3 increases.

As illustrated in FIG. 5, in the battery system 101a in the charged state, when the thicknesses of the gas cushions 3a decrease due to an increase in the thicknesses of the battery cells 10a and the pressure of the gas cushions 3a exceeds the preset value, the cushion controller 6 actuates a relief valve 42. The gas 32 in the gas cushions 3a passes through the sub-pipes 5 and the pipe 4, and then, is released to the outside via the relief valve 42, whereby the pressure of the gas cushions 3 decreases.

According to the battery system 101 of the present embodiment having the above-described configuration, since the compressor 41 and the relief valve 42 are disposed on the pipe 4 as in the battery system 100 of the first embodiment, a uniform pressure can be applied to the battery cells 10 even when the thicknesses of the battery cells 10 change greatly due to charge and discharge. In addition, a tank for storing the gas 32 is not necessary, size reduction is facilitated. Furthermore, heat generated by the battery cells 10 can be absorbed by the liquid 34, thereby making it possible to suppress an increase in the temperature of the battery cells 10 that can be caused by charge and discharge.

It should be noted that the present invention is not limited to the above-described embodiments. For example, the gas cushions 3 are disposed not only between the battery cells 10 but also between the set of the plurality of battery cells 10 and each of the end plates 2a and 2b in the above-described embodiments, but the positions of the gas cushions 3 are not limited thereto. It is sufficient that the gas cushion 3 is disposed in at least one of: the locations between the battery cells 10; the location between the set of the plurality of battery cells 10 and the end plate 2a; or the location between the set of the plurality of battery cells 10 and the end plate 2b.

In the above embodiment, the battery cell 10 has been described as a solid-state battery including the solid electrolyte layer 17, but the battery cell 10 is not limited thereto. The battery cell 10 may be, for example, a nonaqueous battery including an organic electrolytic solution as an electrolyte or a polymer battery including a polymer gel (polymer).

### EXPLANATION OF REFERENCE NUMERALS

1: Cell stack
2a, 2b: End plates
3, 3a: Gas cushion
4: Pipe
5: Sub-pipe
6: Cushion controller
10, 10a: Battery cell
11: Positive electrode layer
11a: Positive electrode lead
12: Positive electrode current collector
13: Positive electrode active material layer
14: Negative electrode layer
14a: Negative electrode lead
15: Negative electrode current collector
16: Metal layer
17: Solid electrolyte layer
18: Electrode laminate
19: Exterior body
31: Elastic container
32: Gas
33: Outer elastic container
34: Liquid
41: Compressor
42: Relief valve
100, 100a, 101, 101a: Battery system

What is claimed is:

1. A battery system comprising:
a cell stack in which a set of a plurality of battery cells are stacked;
a pair of end plates disposed at opposite ends of the cell stack in a stacking direction, respectively;
at least one elastic container having an interior filled with a gas, the at least one elastic container being disposed between the battery cells and/or between the set of the plurality of battery cell and each of the end plates;
a pipe having a compressor and a relief valve;
a sub-pipe connecting the pipe to the at least one elastic container; and
a controller, wherein
the controller actuates the compressor to introduce the gas into the pipe in a case where a pressure of the at least one elastic container is less than a preset value, and actuates the relief valve to release the gas from the pipe in a case where the pressure of the at least one elastic container exceeds the preset value.

2. The battery system according to claim 1, wherein
the elastic container is housed in an outer elastic container, and
a space between the elastic container and the outer elastic container is filled with a liquid.
